(19) United States
(12) Patent Application Publication
(10) Pub. No.: US 2013/0289795 A1
(43) Pub. Date: Oct. 31, 2013

(54) ROOM TEMPERATURE CONTROL SYSTEM AND ROOM TEMPERATURE CONTROL METHOD FOR ROOMS HEATED BY HOT WATER

(71) Applicant: AFRISO-EUO-INDEX GMBH, Guglingen (DE)

(72) Inventor: Ulrich ALDINGER, Stuttgart (DE)

(73) Assignee: AFRISO-EUO-INDEX GmbH, Guglingen (DE)

(21) Appl. No.: 13/866,618

(22) Filed: Apr. 19, 2013

(30) Foreign Application Priority Data
Apr. 27, 2012 (EP) 12 165 999.9

(51) Int. Cl. G05D 23/19

(52) U.S. Cl. CPC G05D 23/19
USPC 700/300

(57) ABSTRACT

A room temperature control system for controlling the room temperature in rooms heated by hot water to a respective setpoint temperature includes, for each room heated by hot water, a hot water heating circuit for heating or cooling the room, at least one temperature sensor which is arranged in the room for measuring the actual temperature, a setpoint temperature-adjustment device which is arranged in the room for adjusting the setpoint temperature and a controller for driving a valve of the hot water heating circuit on the basis of the measured actual temperature and the adjusted setpoint temperature. The invention the setpoint temperature-adjustment devices are connected to the respective controllers via an interconnected computer which passes the setpoint temperatures provided by the setpoint temperature-adjustment devices on to the controllers either unchanged or modified, based on additional measurement, evaluation or user data.

### CROSS REFERENCE TO RELATED APPLICATIONS

This application claims priority under 35 U.S.C. §119(a) to European Patent Application No. 12 165 999.9, filed Apr. 27, 2012, the entire contents of which are hereby incorporated by reference.

### TECHNICAL FIELD

The present invention relates to a room temperature control system for controlling the room temperature in rooms heated by hot water to a respective setpoint temperature, comprising, for each room heated by hot water, a hot water heating circuit for heating or cooling the room, at least one temperature sensor which is arranged in the room for measuring the actual temperature, a setpoint temperature-adjustment device which is arranged in the room for adjusting the setpoint temperature, and a controller for driving a valve of the hot water heating circuit on the basis of the measured actual temperature and the adjusted setpoint temperature, and also to a method for controlling the room temperature in rooms heated by hot water.

### BACKGROUND OF THE INVENTION

A room temperature control system of this type is known e.g. from EP 2 320 294 A1.

In this known room temperature control system, the actual temperatures measured by a temperature sensor are transferred to a controller via wire or radio, wherein the controller drives a valve of the hot water heating circuit of the room on the basis of the actual temperatures and the setpoint temperatures. The desired setpoint temperature of the room is adjusted directly on the temperature sensor via a setpoint temperature-adjustment device and is also transferred to the respective controller via wire or radio.

It is the underlying purpose of the present invention to further improve the control of a room temperature control system of the above-mentioned type and, in particular, facilitate the adjustability of the setpoint temperature.

### SUMMARY OF THE INVENTION

This object is achieved in accordance with the invention in that the setpoint temperature-adjustment devices are connected to the respective controllers via an interconnected computer which passes the setpoint temperatures provided by the setpoint temperature-adjustment devices on to the controllers either unchanged or modified, based on additional measurement, evaluation or user data.

In accordance with the invention, the setpoint temperatures which are locally adjusted in the rooms are passed on to the controllers only by the interconnected computer which modifies the adjusted setpoint temperatures, if required, in such a manner that the desired control behavior is obtained. In this case, the computer does not pass on the actually adjusted setpoint temperatures to the individual controllers, but correspondingly higher or lower setpoint temperatures. The exclusive control of adjusting the setpoint temperatures has therefore been transferred from the setpoint temperature-adjustment devices to the computer.

The temperature sensors are preferably also connected to the respective controllers via the interconnected computer which can correspondingly modify the setpoint temperatures to be passed on to the controllers on the basis of the measured actual temperatures.

At least one air moisture sensor is furthermore preferably arranged in each room heated by hot water for measuring the air moisture, wherein the air moisture sensors are connected to the respective controllers via the interconnected computer which can correspondingly modify the setpoint temperatures to be passed on to the controllers on the basis of the measured air moistures. If, for example, the setpoint temperature which is adjusted for a room is lower than the dew point temperature which is representative of the measured air moisture, the computer passes a modified setpoint temperature on to the controller, which temperature is higher than the mentioned dew point temperature.

With particular preference, the computer comprises a data storage for storing the setpoint temperatures adjusted at the setpoint temperature-adjustment devices and/or the setpoint temperatures passed on to the controllers and/or the measured actual temperatures and/or the measured air moistures and/or the control signals output by the controllers to the valves thereof, and is, in particular, programmed to modify the setpoint temperatures to be passed on to the controllers based on the stored data (“history”). The computer is advantageously programmed to evaluate the stored data and display optimization proposals to the room temperature control system. Deteriorations of the efficiency of the room temperature control system can e.g. be detected on the basis of the data stored over a period of years and corresponding countermeasures can be taken. The computer can also determine the valve opening times from the control signals of the valves, which have been stored in the past, and calculate therefrom optimized flow rates in the individual hot water heating circuits (“hydraulic balance”) which can then be correspondingly adjusted by the user.

A network data interface is advantageously provided via which the setpoint temperatures provided by the setpoint temperature-adjustment devices and/or the measured actual temperatures and/or the measured air moistures and/or the output control signals and/or the stored data can be retrieved via a network and via which the setpoint temperatures which the computer has passed on to the controllers can be modified. When the user has the appropriate authorization, the user can then access all this data e.g. using any computer which is connected to the Internet or using a smartphone with corresponding app. The setpoint temperature can then be adjusted or changed by the user directly in the inventive computer via the Internet interface, e.g. via the app on the smartphone.

In a further aspect, the invention also relates to a method for controlling the room temperature in rooms heated by hot water, wherein the actual temperature of each room is measured by at least one temperature sensor and is controlled in each case to a setpoint temperature via a controller which drives a hot water heating circuit of the room on the basis of the measured actual temperature, wherein in accordance with the invention, the setpoint temperatures which are locally adjusted in the rooms are passed on to the controllers either unchanged or modified, based on additional measurement, evaluation or user data. The temperature data can be evaluated for each room separately and/or across rooms for several rooms, in particular, for all rooms.

Further advantages and advantageous embodiments of the subject matter of the invention can be extracted from the description, the drawing and the claims. The features mentioned above and below can be used either individually or collectively in arbitrary combinations. The embodiments shown and described are not to be taken as an exhaustive enumeration but have exemplary character for describing the invention.

### BRIEF DESCRIPTION OF THE DRAWING

In the drawings:

FIGS. 1a-1c show different variants of a first embodiment of the inventive room temperature control system; and

FIG. 2 shows a second embodiment of the inventive room temperature control system.

### DETAILED DESCRIPTION OF THE INVENTION

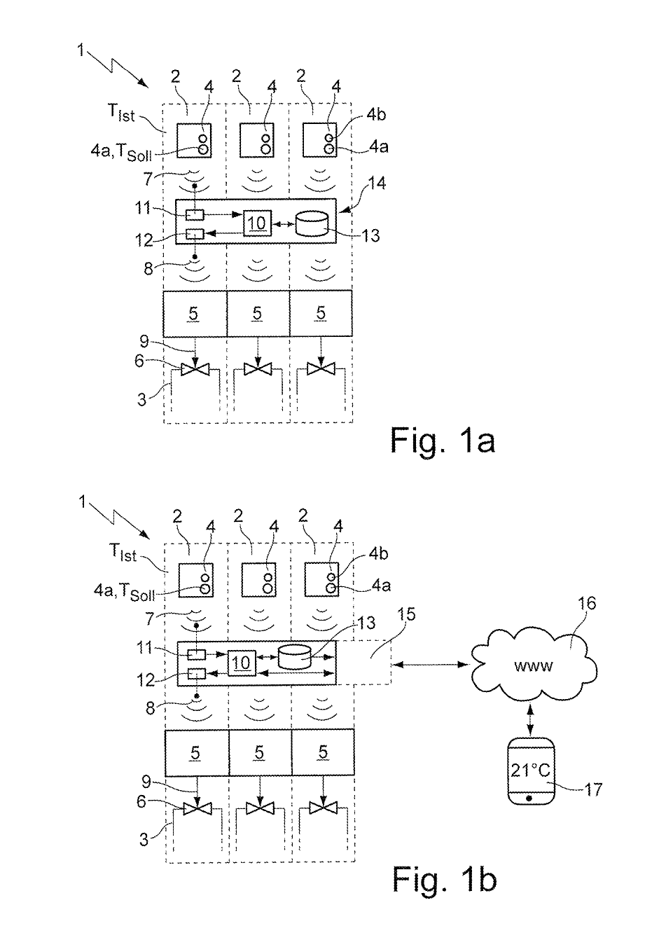

The room temperature control system 1 illustrated in FIG. 1a is used for controlling the room temperature in several rooms 2 heated by hot water to a respective setpoint temperature T_{Soll}.

The room temperature control system 1 comprises for each room 2 heated by hot water one hot water heating circuit 3 for heating or cooling the room 2, at least one temperature sensor 4 arranged in the room 2 for measuring the actual temperature T_{Ist}, a setpoint temperature-adjustment device 4a arranged in the room 2 for adjusting the setpoint temperature T_{Soll}, at least one air moisture sensor 4b arranged in the room 2 for measuring the air moisture, and a controller 5 for driving a valve 6 of the hot water heating circuit 3 based on the measured actual temperature T_{Ist} and the adjusted setpoint temperature T_{Soll}. In the illustrated embodiment, the setpoint temperature-adjustment device 4a and the air moisture sensor 4b are arranged on the temperature sensor 4 or are integrated in its housing.

The temperature sensors 4, the setpoint temperature-adjustment device 4a and the air moisture sensors 4b are connected to their respective controllers 5 via an interconnected computer 10 which evaluates the actual temperatures T_{Ist} measured by the temperature sensors 4, the setpoint temperatures T_{Soll} adjusted at the setpoint temperature-adjustment devices 4a, and the air moistures measured by the air moisture sensors 4b individually or collectively or across rooms, and passes the adjusted setpoint temperatures T_{Soll} on to the respective controller 5 either unchanged or modified, based on this evaluation.

The data transfer from the temperature sensors 4, from the setpoint temperature-adjustment devices 4a and from the air moisture sensors 4b to the computer 10 and from the computer 10 to the controllers 5 is thereby realized in each case by radio signals 7, 8. To this end, the computer 10 comprises a radio receiver 11 for receiving the transmitted data and a radio transmitter 12 for transmitting the actual and setpoint temperatures T_{Ist}, T_{Soll} to the individual controllers 5. The computer (e.g. a microprocessor) 10 moreover stores in a data storage 13 all data received and passed on, the associated evaluations and also the control signals 9 output by the controllers 5 to each of their valves 6. The computer 10, the radio receiver and transmitter 11, 12 and the data storage 13 can be designed in the form of a unit or a module 14.

The setpoint temperatures T_{Soll} which are locally adjusted in the rooms 2 and the measured actual temperatures T_{Ist} are therefore not directly passed on to the controllers 5 but only via the interconnected computer 10 which modifies these adjusted setpoint temperatures, if necessary, in such a manner that the desired control behavior is obtained. In this case, the computer 10 does not pass on the actually adjusted setpoint temperatures T_{Soll} to the individual controllers 5, but correspondingly higher or lower setpoint temperatures. For this reason, the computer 10 has the exclusive control of adjusting the setpoint temperatures.

The computer 10 is also programmed to display to the user optimization proposals for the room temperature control system 1 based on the stored data. On the basis of data stored over a period of years, it is thereby possible e.g. to detect deteriorations of the efficiency of the room temperature control system 1 and to take corresponding countermeasures. The computer 10 can also determine the valve opening times from the control signals 9 of the valves 6, which signals have been stored in the past, and calculate therefrom optimized flow rates in the individual hot water heating cycles 3 (“hydraulic balance”) which can then be correspondingly adjusted either electrically or by the user.

In the room temperature control system 1 illustrated in FIG. 1b, the computer 10 and the data storage 13 are additionally connected to the Internet 16 via an Internet interface 15 such that the setpoint temperatures T_{Soll} provided by the setpoint temperature-adjustment devices 4a, the measured actual temperatures T_{Ist}, the measured air moistures, the output control signals and also the stored data are available worldwide. With the appropriate authorization, all this data can be accessed e.g. using any computer which is connected to the Internet 16 or using a smartphone 17 with corresponding app. This can be a decisive advantage for rooms which are accessible to the public, such as e.g. schools, and prevent or warn of major damages, in particular, in the winter during frost periods. A minimum actual temperature can be adjusted in the app for each controller 5 or each room 2, and when the temperature is fallen below, a warning is issued in the form of a ring tone and a temperature profile display.

The setpoint temperatures T_{Soll} provided by the setpoint temperature-adjustment device 4a can be modified by the user in the computer 10 via the Internet interface 15, e.g. via the app on the smartphone 17. In this case, the exclusive control of adjusting the setpoint temperature is transferred to the authorized smartphone. This can be arbitrarily performed for individual, several or all controllers 5. The exclusive control of adjustment can be assigned individually, temporarily, reversibly or permanently. All possible parameters of the room temperature control system 1 can be viewed, adjusted or modified either locally on the computer 10 or via the smartphone 17.

The room temperature control system 1 illustrated in FIG. 1c differs from that of FIG. 1b only in that in this case, the computer 10 is connected to the controllers 5 not in a wireless manner but via an electric line 8′. The temperature sensors 4, the setpoint temperature-adjustment devices 4a and the air moisture sensors 4b can also be connected to the computer 10 by wire or a bus instead of a radio connection.

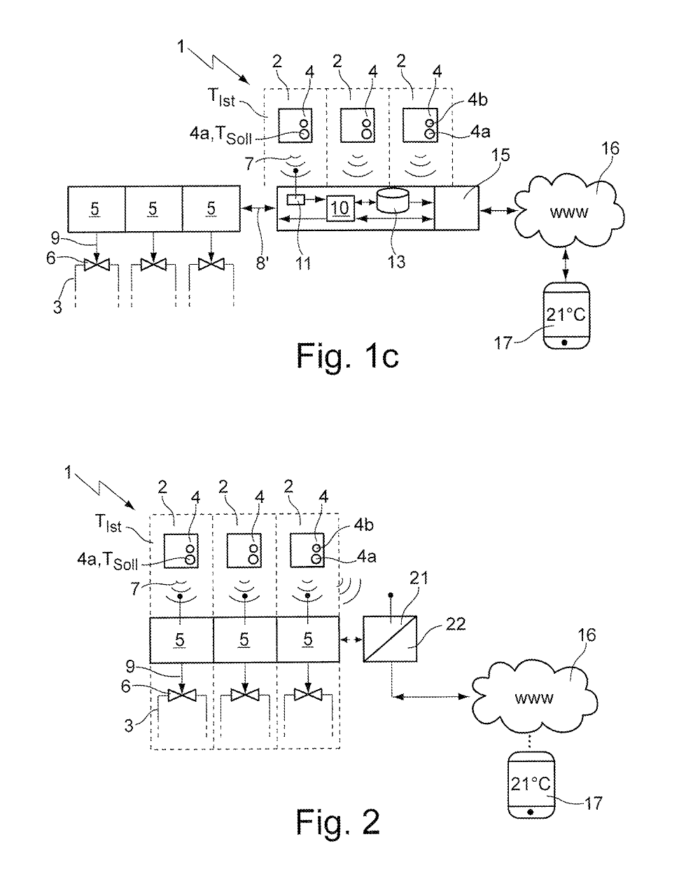

In contrast to FIG. 1, the room temperature control system 1 illustrated in FIG. 2 does not have a computer 10, but the measurement data and the adjusted setpoint temperatures are transmitted via radio 7 directly to the individual controllers 5 which then correspondingly drive the valves 6 of the hot water heating circuits 3 via control signals 9. The overall data exchange or radio communication is also received, i.e. monitored, by a separate radio receiver 21 and can be retrieved via the Internet 16 through an Internet interface 22 which is connected to the radio receiver 21. In this way, both the actual room temperature and the adjusted setpoint temperature of the rooms 2 heated by hot water can be read at any time and everywhere e.g. using smartphones 17. As is indicated by broken lines, the controllers 5 can also be connected to this Internet interface 22 so that e.g. the control signals 9 output by the controllers 5 to the valves 6 thereof can be retrieved via the Internet 16.

While specific embodiments of the invention have been shown and described in detail to illustrate the inventive principles, it will be understood that the invention may be embodied otherwise without departing from such principle.

I claim:

1. A room temperature control system for controlling room temperature in rooms heated by hot water to a respective setpoint temperature in each case, comprising: for each room heated by hot water, a hot water heating circuit for heating or cooling the room; at least one temperature sensor arranged in the room for measuring the actual temperature; a setpoint temperature-adjustment device arranged in the room for adjusting the setpoint temperature; a controller for driving a valve of the hot water heating circuit based on the measured actual temperature and the adjusted setpoint temperature; and an interconnected computer that connects the setpoint temperature-adjustment devices to the respective controllers and passes the setpoint temperatures provided by the setpoint temperature-adjustment devices to the controllers either unchanged or modified, based on additional measurement, evaluation or user data.

2. The room temperature control system according to claim 1, wherein the temperature sensors are also connected to the respective controllers via the interconnected computer which passes the setpoint temperatures on to the controllers either unchanged or modified, based on the measured actual temperatures.

3. The room temperature control system according to claim 1, wherein at least one air moisture sensor is arranged in each room heated by hot water for measuring air moisture, and the air moisture sensors are connected to the respective controllers via the interconnected computer which passes the setpoint temperatures on to the controllers either unchanged or modified, based on the measured air moistures.

4. The room temperature control system according to claim 3, wherein the computer comprises a data storage for storing the setpoint temperatures adjusted at the setpoint temperature-adjustment devices and/or the setpoint temperatures passed on to the controllers and/or the measured actual temperatures and/or the measured air moistures and/or the control signals output by the controllers to the valves thereof.

5. The room temperature control system according to claim 4, wherein the computer is programmed to modify the setpoint temperatures to be passed on to the controllers, based on the stored data.

6. The room temperature control system according to claim 4, wherein the computer is programmed to evaluate the stored data and display optimization proposals for hydraulic balance of the hot water circuit.

7. The room temperature control system according to claim 3, wherein the computer is connected to the setpoint temperature-adjustment devices and/or to the temperature sensors and/or to the air moisture sensors and/or to the controllers via radio or electric lines.

8. The room temperature control system according to claim 3, wherein a network data interface via which the setpoint temperatures provided by the setpoint temperature-adjustment devices and/or the measured actual temperatures and/or the measured air moistures and/or the output control signals and/or the stored data can be retrieved via a network via which the setpoint temperatures to be passed on to the controllers can also be modified.

9. The room temperature control system according to claim 8, wherein the data interface is an interface to the Internet and/or to a radio network and/or to a bus system.

10. A room temperature control system for controlling room temperature in rooms heated by hot water to a respective setpoint temperature in each case, comprising: for each room heated by hot water, a hot water heating circuit for heating or cooling the room; at least one temperature sensor arranged in the room for measuring the actual temperature; a setpoint temperature-adjustment device arranged in the room for adjusting the setpoint temperature; a controller for driving a valve of the hot water heating circuit based on the measured actual temperature and the adjusted setpoint temperature; and a network data interface via which the setpoint temperatures provided by the setpoint temperature-adjustment devices and/or the measured actual temperatures and/or the measured air moistures and/or the output control signals and/or the stored data can be retrieved via a network via which the setpoint temperatures to be passed on to the controllers can also be modified.

11. A method of controlling room temperature in rooms heated by hot water comprising the steps of: measuring actual temperature of each room by at least one temperature sensor; controlling the temperature in each case to a setpoint temperature by a controller which controls a hot water circuit of the room based on the measured actual temperature; and passing the setpoint temperatures which are locally adjusted in the rooms on to the controllers either unchanged or modified, based on additional measurement, evaluation or user data.

12. The method according to claim 11, wherein the setpoint temperatures to be passed on to the controllers are modified based on the measured actual temperatures.

13. The method according to claim 11, wherein the setpoint temperatures to be passed on to the controllers are modified based on air moistures prevailing in the rooms.

14. The method according to claim 13, including storing the setpoint temperatures which are locally set in the rooms and/or the setpoint temperatures passed on to the controllers and/or the measured actual temperatures and/or the measured air moistures and/or the control signals output by the controllers to the valves thereof, and the setpoint temperatures to be passed on to the individual controllers are modified based on the stored data.

15. The method according to claim 14, wherein the stored data is evaluated and, based on the evaluation, optimization proposals are displayed for hydraulic balance of the hot water heating circuits.

16. The method according to claim 13, wherein the setpoint temperatures which are locally set in the rooms and/or the measured actual temperatures and/or the measured air moistures and/or the output control signals and/or the stored data are retrieved by a user via a network and the setpoint temperatures to be passed on to the controllers are modified by the user via the network.

17. The method according to claim 16, including retrieving the setpoint temperatures which are locally set in the rooms and/or the measured actual temperatures and/or the measured air moistures and/or the output actual signals and/or the stored data and/or modifying of data using a smartphone.

18. A method of controlling room temperature in rooms heated by hot water comprising the steps of: measuring actual temperature of each room by at least one temperature sensor; and controlling the temperature in each case to a setpoint temperature by a controller which controls a hot water circuit of the room based on the measured actual temperature; retrieving the setpoint temperatures which are locally set in the rooms and/or measured actual temperatures and/or measured air moistures and/or output control signals and/or stored data by a network; and modifying the setpoint temperatures to be passed on to the controllers via the network.
